(19) United States
(12) Patent Application Publication
(10) Pub. No.: US 2026/0251780 A1
(43) Pub. Date: Aug. 27, 2026

(54) SIGNAL PROCESSING APPARATUS, SIGNAL PROCESSING METHOD, AND NON-TRANSITORY COMPUTER READABLE MEDIUM

(71) Applicant: NEC Corporation, Tokyo (JP)

(72) Inventor: Taichi TANAKA, Tokyo (JP)

(73) Assignee: NEC Corporation, Tokyo (JP)

(21) Appl. No.: 19/144,991

(22) PCT Filed: Jan. 12, 2024
(86) PCT No.: PCT/JP2024/000542

§ 371 Date: Jul. 1, 2025

(30) Foreign Application Priority Data
Jan. 12, 2023 (JP) 2023-002920

(51) Int. Cl. G01S 13/90; G01S 13/60

(52) U.S. Cl. CPC G01S 13/90; G01S 13/605

(57) ABSTRACT

This signal processing device performs Fourier transform on a reflection signal into first signal data. The reflection signal represents reflection from a scatterer with respect to radar emitted from a flying object. The signal processing device calculates each phase of second signal data after Fourier transform on the reflection signal when the radar is virtually emitted to plurality of reference points, interpolating the first signal data by using interpolation formula generated using with the phase of second signal data, and performing inverse Fourier transform.

### TECHNICAL FIELD

The present invention relates to a signal processing apparatus, a signal processing method, and a recording medium.

### BACKGROUND ART

PTL 1 discloses a technique related to a radar sensor including a plurality of transmission antennas and for estimating a relative speed of a target object.

PTL 2 discloses a technique related to a synthetic aperture radar device and for reducing an error caused in a relative positional relationship between a fixed target and a moving target and superimposing images of both the fixed target and the moving target on each other.

PTL 3 discloses a technique related to a synthetic aperture radar device that clarifies a method of determining the order N of the optimum polynomial and obtains an image with improved resolution.

NPL 1 discloses a technique related to Omega-K Algorithm in a SAR image generation method.

NPL 2 discloses a technique related to SVD-Stolt in a SAR image generation method.

NPL 3 discloses a technique related to Extended Wavenumber domain in a SAR image generation method.

### CITATION LIST

### Patent Literature

PTL 1: JP 2020-503519 A
PTL 2: JP 2017-106799 A
PTL 3: JP 2000-266845 A

### Non Patent Literature

NPL 1: Y. L. Neo, and F. H. Wong, “Interpretations of the Omega-K Algorithm and Comparisons with other Algorithms”, [online], 2003 IEEE, [retrieved on Jan. 12, 2023], Internet <http://geo.uzh.ch/microsite/rsl-documents/research/SARlab/GMTILiterature/Ver09/PDF/CNW03.pdf>
NPL 2: D. D′Aria, A. Monti Guarnieri, “High resolution spaceborne SAR focusing by SVD-STOLT”, [online], [retrieved on Jan. 12, 2023], Internet <https://www.researchgate.net/profile/Davide-Daria/publication/3449863_High-resolution_spaceborne_SAR_focusing_by_SVD-stolt/links/54e714e00cf277664ff7802f/High-resolution-spaceborne-SAR-focusing-by-SVD-stolt.pdf>
NPL 3: A. Reigber, E. Alivizatos, A. Potsis and A. Moreira, “Extended wavenumber-domain synthetic aperture radar focusing with integrated motion compensation”, [online], IEE Proc.-Radar Sonar Navig., Vol. 153, No. 3, June 2006, [retrieved on Jan. 12, 2023], Internet <https://www.researchgate.net/profile/Alberto-Moreira-2/publication/3357927_Extended_wavenumber-domain_synthetic_aperture_radar_focusing_with_integrated_motion_compensation/links/00b49 51ccc4bb99e83000000/Extended-wavenumber-domain-synthetic-aperture-radar-focusing-with-integrated-motion-compensation.pdf>

### SUMMARY OF INVENTION

### Technical Problem

PTL 2 and PTL 3 described above disclose a technique related to a synthetic aperture radar (SAR) image. In the SAR image generation methods described above, when the squint angle of the flying object increases, the imaging performance may deteriorate.

In view of the above-described problems, an object of the present invention is to provide a signal processing apparatus, a signal processing method, and a recording medium capable of improving imaging performance.

### Solution to Problem

According to an aspect of the present invention, there is provided a signal processing apparatus including
transformation means for performing Fourier transform on a reflection signal into first signal data in a frequency domain, the reflection signal representing reflection from a scatterer with respect to radar emitted from a flying object,
reference point generation means for generating a plurality of reference points arranged in a direction obliquely inclined with respect to a direction perpendicular to a traveling direction of the flying object in a plane defined by the traveling direction and an emission direction in which the flying object emits the radar,
calculation means for calculating each phase of second signal data in the frequency domain after Fourier transform on the reflection signal when the radar is virtually emitted to the plurality of reference points,
interpolation formula generation means for generating an interpolation formula by using each phase of the second signal data calculated by the calculation means, and
interpolation processing means for interpolating the first signal data transformed by the transformation means by using the interpolation formula, and performing inverse Fourier transform.

According to another aspect of the present invention, there is provided a signal processing method including
by one or more computers,
performing Fourier transform on a reflection signal into first signal data in a frequency domain, the reflection signal representing reflection from a scatterer with respect to radar emitted from a flying object,
generating a plurality of reference points arranged in a direction obliquely inclined with respect to a direction perpendicular to a traveling direction of the flying object in a plane defined by the traveling direction and an emission direction in which the flying object emits the radar,
calculating each phase of second signal data in the frequency domain after Fourier transform on the reflection signal when the radar is virtually emitted to the plurality of reference points,
generating an interpolation formula by using each phase of the second signal data, and
interpolating the first signal data by using the interpolation formula, and performing inverse Fourier transform.

According to still another aspect of the present invention, there is provided a computer-readable recording medium recording a program for causing a computer to execute
a procedure of performing Fourier transform on a reflection signal into first signal data in a frequency domain, the reflection signal representing reflection from a scatterer with respect to radar emitted from a flying object,
a procedure of generating a plurality of reference points arranged in a direction obliquely inclined with respect to a direction perpendicular to a traveling direction of the flying object in a plane defined by the traveling direction and an emission direction in which the flying object emits the radar,
a procedure of calculating each phase of second signal data in the frequency domain after Fourier transform on the reflection signal when the radar is virtually emitted to the plurality of reference points,
a procedure of generating an interpolation formula by using each phase of the second signal data, and
a procedure of interpolating the first signal data by using the interpolation formula, and performing inverse Fourier transform.

### Advantageous Effects of Invention

According to one aspect of the present invention, it is possible to obtain a signal processing apparatus, a signal processing method, and a program capable of improving imaging performance.

### BRIEF DESCRIPTION OF DRAWINGS

FIG. 1 is a schematic diagram when an artificial satellite emits radar to a ground surface.

FIG. 2 is a schematic diagram of a form in which an artificial satellite emits radar to a scatterer on a ground surface.

FIG. 3 is a schematic diagram for describing a signal related to an artificial satellite.

FIG. 4 is a block diagram illustrating an outline of a signal processing apparatus according to a first example embodiment.

FIG. 5 is a schematic diagram for describing a reference point F in the first example embodiment.

FIG. 6 is a diagram illustrating a hardware configuration example of the signal processing apparatus.

FIG. 7 is a diagram illustrating a conventional method of generating a plurality of reference points.

FIG. 8 is a block diagram illustrating an outline of a signal processing apparatus according to a second example embodiment.

FIG. 9 is a flowchart until an interpolation formula generation unit generates an interpolation formula.

FIG. 10 is a flowchart illustrating details of an interpolation formula generation method.

FIG. 11 is a flowchart up to generation of a SAR image.

FIG. 12 is a flowchart when a reference point generation unit according to a third example embodiment generates a reference point F.

FIG. 13 is a block diagram illustrating an outline of a signal processing apparatus according to a fourth example embodiment.

FIG. 14 is a flowchart illustrating processing of a coordinate system transformation unit according to the fourth example embodiment.

FIG. 15 is a block diagram illustrating an outline of a signal processing apparatus according to a fifth example embodiment.

FIG. 16 is a flowchart illustrating processing of a position information transformation unit according to the fifth example embodiment.

FIG. 17 is a block diagram illustrating an outline of a signal processing apparatus according to a sixth example embodiment.

FIG. 18 is a flowchart until an interpolation formula generation unit according to the sixth example embodiment generates an interpolation formula.

FIG. 19 is a flowchart illustrating details of an interpolation formula generation method according to the sixth example embodiment.

FIG. 20 is a flowchart up to generation of a SAR image in the sixth example embodiment. 20

FIG. 21 is a block diagram illustrating an outline of a signal processing apparatus according to a seventh example embodiment.

### EXAMPLE EMBODIMENT

Hereinafter, example embodiments of the present invention will be described with reference to the drawings. In all the drawings, the same components are denoted by the same reference signs, and the description thereof will be omitted as appropriate.

A synthetic aperture radar (SAR) technique is a technique for artificially synthesizing an aperture in such a way as to obtain an image (SAR image) equivalent to an antenna having a large aperture, by transmitting and receiving an electromagnetic wave (radar) by an antenna mounted on a flying object (artificial satellite, airplane, or the like) while the flying object moves. An artificial satellite (SAR satellite) will be described below as an example of the flying object.

### Definition of Terms

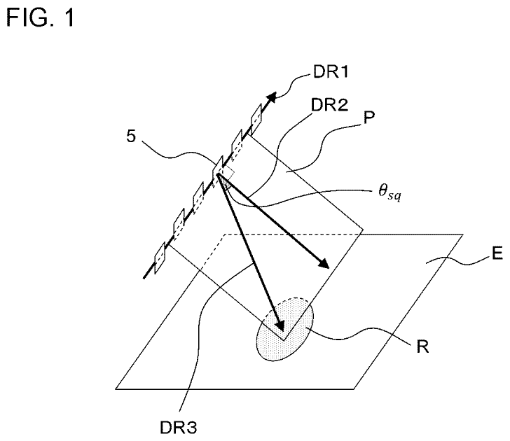

FIG. 1 is a schematic diagram when an artificial satellite 5 emits radar to a ground surface E. With reference to FIG. 1, terms in the example embodiment will be defined. The ground surface E actually has a spherical shape with irregularities, but in FIG. 1, the ground surface is simply represented by a plane.

DR1 illustrated in FIG. 1 indicates a traveling direction of the artificial satellite 5. Each of parallelogram shapes depicted along the traveling direction DR1 indicates the satellite 5. Thus, the movement trajectory of the artificial satellite 5 is illustrated.

In the synthetic aperture radar, by synthesizing reflections of electromagnetic waves emitted from a plurality of satellite positions with a predetermined spread (width), the reflection of the electromagnetic waves in a case where electromagnetic waves are emitted from a certain satellite position with a small spread (width) is calculated. The satellite position after synthesis at that time is referred to as azimuth or the like. Since there is no actual difference from the satellite position, the azimuth and the satellite position are not distinguished here. That is, an azimuth direction is the traveling direction DR1. The coordinate axis developed in the azimuth direction is referred to as an azimuth axis.

DR2 is a vertical direction DR2 perpendicular to the azimuth direction DR1 (=traveling direction DR1) in a plane P. The vertical direction DR2 is a direction in which the Doppler becomes 0. The direction in which the Doppler becomes 0 is also referred to as a zero Doppler direction. The vertical direction DR2 is also referred to as the zero Doppler direction DR2 below.

The plane P is a plane defined by the azimuth direction DR1 and the emission direction DR3. The emission direction DR3 is a direction in which the artificial satellite 5 emits the radar. The emission direction DR3 is a direction in which the center of the radar of the artificial satellite 5 travels. The emission direction DR3 is also a direction in which the antenna of the artificial satellite 5 is directed. In the case of squinting, the emission direction DR3 is provided obliquely inclined with respect to the zero Doppler direction DR2. The emission direction DR3 is also referred to as a range direction DR3 below.

The artificial satellite 5 emits radar (=electromagnetic waves) toward the ground surface E and receives a reflection signal representing reflection of the radar. The radar emitted from the antenna of the artificial satellite 5 in the range direction DR3 hits an image capturing region R and bounces back, and the phase delay, the intensity of reflection, and the like are recorded. A SAR image is formed using data related to the reflection signal. Since the radar has a predetermined width, the radar is emitted conically toward the ground surface E. The image capturing region R in FIG. 1 indicates a region to which the radar is emitted on the ground surface E.

An angle formed by the zero Doppler direction DR2 and the range direction DR3 is defined as a squint angle θ_{sq}. The range direction DR3 is inclined by θ_{sq} with respect to the zero Doppler direction DR2. A case where the squint angle θ sq exceeds approximately 5 degrees is defined as high squint. The representative squint angle is, for example, a squint angle at which the antenna is directed for the longest time among squint angles of the artificial satellite 5 in a certain satellite orbit.

In general, in image formation of a SAR image, the zero Doppler direction and the range direction are often handled as approximately the same direction. However, in the case of high squint, it is not possible to ignore the difference in direction between the zero Doppler direction and the range direction, and thus it is preferable to handle the zero Doppler direction and the range direction by clearly distinguishing the zero Doppler direction and the range direction from each other.

### (Description of Coordinate System)

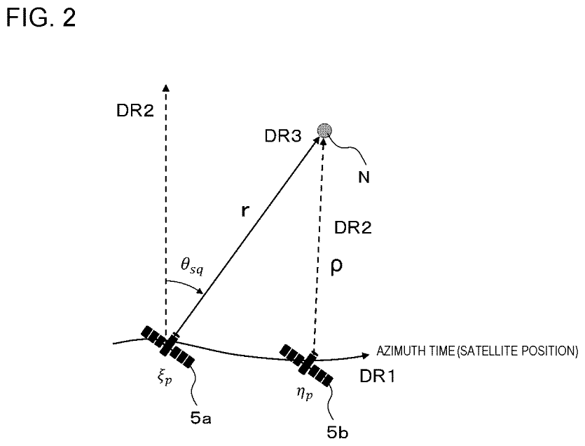

FIG. 2 is a schematic diagram of a form in which the artificial satellite 5 emits radar to a scatterer N on the ground surface E. FIG. 2 illustrates a form when the artificial satellite 5 emits radar to the scatterer N in the image capturing region R of the ground surface E. The scatterer N represents a virtual point on the ground surface E, and is a point at which emission of the radar is received and the radar is reflected in various directions. A coordinate system handled in the present specification will be described with reference to FIG. 2.

### (ξ-r System)

The time at which an artificial satellite 5a comes in front of a certain scatterer N in the range direction DR3 (=emission direction DR3) is defined as a beam passage azimuth time (beam crossing time) ξₚ. The beam passage azimuth time ξₚ is a time when the scatterer N comes directly in front of the antenna (radar) in a case where the squint angle θ_{sq} does not change (=representative squint angle). The beam passage azimuth time ξₚ is a time when the center of the radar emitted by the artificial satellite 5a passes through each scatterer N.

At the beam passage azimuth time ξₚ, a distance from the artificial satellite 5a to the scatterer N in the range direction DR3 is defined as a range r.

A coordinate system in which one axis is an axis representing the range and the other axis is an axis representing the beam passage azimuth time ξₚ is referred to as a ξ-r system below.

### (η-p System)

The time when an artificial satellite 5b comes in front of a certain scatterer N in the zero Doppler direction DR2 (=vertical direction DR2) is defined as the nearest time ηₚ. The nearest time ηₚ is also a time when a distance between a certain scatterer N and the artificial satellite 5b is nearest.

At the nearest time ηₚ, the distance from the artificial satellite 5a to the scatterer N in the zero Doppler direction DR2 is defined as a zero Doppler range ρ.

A coordinate system in which one axis is an axis representing the zero Doppler range p and the other axis is an axis representing the nearest time ηp is referred to as an η-p system below.

As illustrated in FIG. 1, the terms and the coordinate systems have been described based on a flat ground surface E and an orbit that is a straight line parallel to the ground surface E, but the same applies to a spherical ground surface E and a curved satellite orbit. It is known that a radar image can be acquired by approximating a ground surface to a plane, and approximating a satellite orbit to a straight line in contrast to a radar image acquired with the ground surface which is a curved surface and the satellite orbit which is a curved line. Although the squint angle in this approximate geometry is referred to as an effective squint angle or the like, these are not particularly distinguished in the following description.

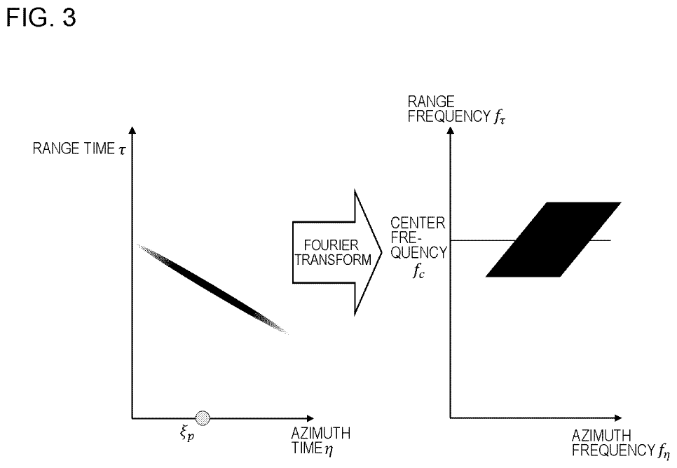

FIG. 3 is a schematic diagram for describing a signal related to the artificial satellite 5. The radar mounted on the artificial satellite 5 emits (or discharges) pulses (pulse signals) of electromagnetic waves to an observation region (image capturing region R) one after another.

The left diagram of FIG. 3 is a diagram illustrating a relationship between an azimuth time n and a range time τ (which will be described later) when radar is emitted to a certain scatterer N, in the ξ-r system. In the left diagram of FIG. 3, the horizontal axis represents the azimuth time n. The azimuth time n is also the discharging time of the pulse. In the left diagram of FIG. 3, the vertical axis represents the range time t. The range time t represents a time from when a pulse is discharged to a place separated by the range r until a reflection signal (reflected wave) is received. It can also be said that the range time is an elapsed time from a timing at which a radar signal is discharged until a reflection signal representing reflection with respect to the radar signal is received. The vertical axis may be represented by a round-trip distance that is a value obtained by multiplying the speed of light by the range time, or may be represented by the range r (distance) in which the round-trip distance is set to ½.

The width of the elliptical figure in the left diagram of FIG. 3 represents the intensity of the reflection signal. For example, since the radar of the artificial satellite 5 is directed to the front of the scatterer N at the beam passage azimuth time ξₚ in the left diagram of FIG. 3, the intensity of the signal is the strongest.

The right diagram of FIG. 3 is data obtained when two-dimensional Fourier transform is performed on data according to the left diagram of FIG. 3 in the frequency domain. The horizontal axis in the right diagram of FIG. 3 represents the azimuth frequency f_{η} obtained by transforming the azimuth time η into the frequency domain, and the vertical axis in the right diagram of FIG. 3 represents the range frequency f_{c} obtained by transforming the range time τ into the frequency domain. The center frequency f_{c} is the center frequency of a frequency band of radar (electromagnetic waves) emitted by the artificial satellite 5, and is determined in advance for each artificial satellite 5.

For multiple scatterers N, SAR images are formed by aggregating pieces of data related to the reflection signals as illustrated in the left diagram and the right diagram of FIG. 3. That is, the data related to the reflection signal of the radar as illustrated in the left diagram and the right diagram of FIG. 3 can also be referred to as pixel data. The pixel data is a value associated with each of two-dimensional grid cells. In the region of the left diagram of FIG. 3, by setting the two axes of the grid cells to the range time τ and the azimuth time η, the phase and the absolute value (also referred to as amplitude or signal intensity) of each scatterer N are recorded in such a manner that each two-dimensional grid cell is associated with the range time τ and the azimuth time η as the pixel data. In the region of the right diagram of FIG. 3, by setting the two axes of the grid cells to the range frequency and the azimuth frequency, the phase and the absolute value of each scatterer N are recorded in such a manner that each two-dimensional grid cell is associated with the range frequency and the azimuth frequency as the pixel data.

### First Example Embodiment

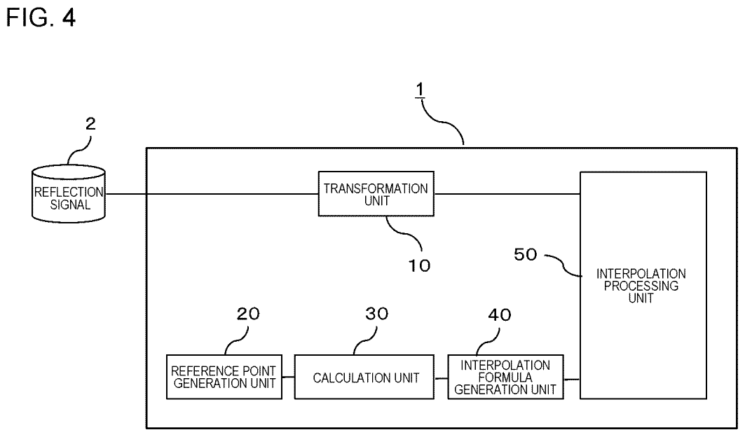

FIG. 4 is a block diagram illustrating an outline of a signal processing apparatus 1 according to a first example embodiment. The signal processing apparatus 1 includes a transformation unit 10, a reference point generation unit 20, a calculation unit 30, an interpolation formula generation unit 40, and an interpolation processing unit 50.

The transformation unit 10 performs two-dimensional Fourier transform on the reflection signal into first signal data in the frequency domain. The reflection signal is a signal representing reflection from the scatterer N with respect to the radar emitted from the artificial satellite 5. The reflection signal may be stored in a storage unit 2 or may be a signal immediately after being received from the artificial satellite 5. A data format of the first signal data is as illustrated in the right diagram of FIG. 3.

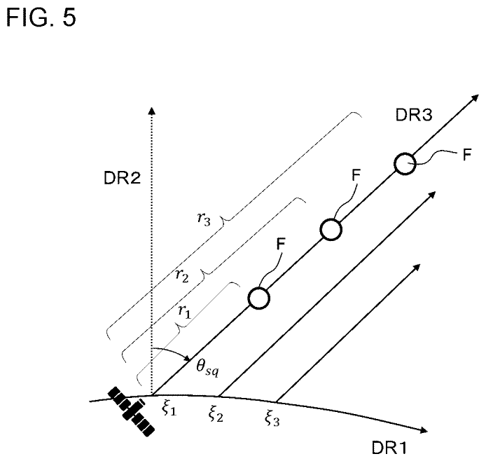

FIG. 5 is a schematic diagram for describing a reference point F in the first example embodiment. The reference point generation unit 20 generates a plurality of reference points F arranged in a direction obliquely inclined with respect to the zero Doppler direction DR2 (=vertical direction DR2). In the first example embodiment, the obliquely inclined direction is the range direction DR3 (=emission direction DR3). That is, the reference point generation unit 20 generates the reference point F in not the η-ρ system but the ξ-r system. The reference point generation unit 20 specifies the range direction DR3 by using the data regarding the squint angle θ_{sq}.

The reference point F corresponds to a virtual point selected from the image capturing region R illustrated in FIG. 1. The reference point F is generated, for example, at the center of the image capturing region R. The reference point F is a point generated to improve imaging accuracy around the reference point F. The reference point F is selected by a user, for example. For example, 30 reference points F are selected, but more or less reference points F may be selected. A plurality of reference points F have different ranges r at the beam passage azimuth time ξ₁ (see r₁ to r₃ in FIG. 5). For example, a plurality of reference points F are generated in the range r of −30 [km] to 30 [km] starting from the center of the image capturing region R.

Returning to FIG. 4, the calculation unit 30 calculates the phase of second signal data in the frequency domain by using the reference point F. The second signal data in the frequency domain is signal data after two-dimensional Fourier transform of the reflection signal when the radar is virtually emitted to the reference point F. The second signal data in the frequency domain is associated with the range frequency and the azimuth frequency similarly to the right diagram of FIG. 3. The calculation unit 30 calculates phases of each item of second signal data in the frequency domain obtained after reflection signals generated when the radar is virtually emitted onto the plurality of reference points F have been subjected to Fourier transform.

The interpolation formula generation unit 40 generates an interpolation formula by using the phase of each piece of the second signal data calculated by the calculation unit 30. The interpolation formula is used to increase the processing accuracy of the interpolation processing unit 50 which will be described later and improve the imaging accuracy. A specific example of the interpolation formula will be described in the second and subsequent example embodiments.

The interpolation processing unit 50 interpolates the first signal data transformed by the transformation unit 10, by using the interpolation formula generated by the interpolation formula generation unit 40, and performs inverse Fourier transform. The data format of the signal data after the inverse Fourier transform is similar to the data described in the left diagram of FIG. 3. The interpolation processing unit 50 outputs the signal data after the inverse Fourier transform. For example, the interpolation processing unit 50 may output the signal data to a SAR image generation unit (not illustrated) that generates a SAR image. A SAR image is formed by collecting a large number of pieces of signal data after the inverse Fourier transform.

### (Hardware Configuration Example)

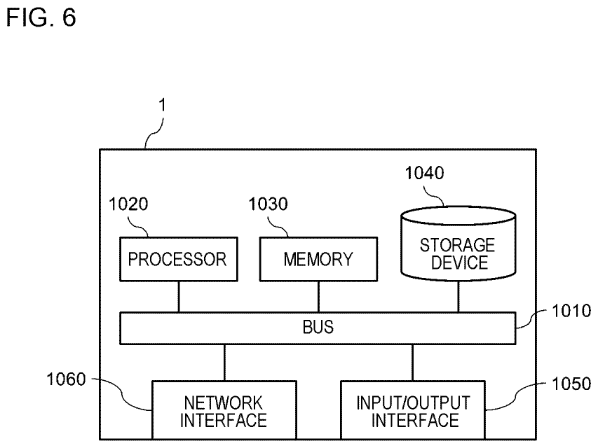

FIG. 6 is a diagram illustrating a hardware configuration example of the signal processing apparatus 1. The signal processing apparatus 1 includes a bus 1010, a processor 1020, a memory 1030, a storage device 1040, an input/output interface 1050, and a network interface 1060.

The bus 1010 is a data transmission path for the processor 1020, the memory 1030, the storage device 1040, the input/output interface 1050, and the network interface 1060 to transmit and receive data to and from each other. The method of connecting the processor 1020 and the like to each other is not limited to the bus connection.

The processor 1020 is a processor achieved by a central processing unit (CPU), a graphics processing unit (GPU), or the like.

The memory 1030 is a main storage device achieved by a random access memory (RAM) or the like.

The storage device 1040 is an auxiliary storage device achieved by a removable medium such as a hard disk drive (HDD), a solid state drive (SSD), and a memory card, or a read only memory (ROM), and has a recording medium. A recording medium of the storage device 1040 stores program modules that enables functions (for example, the transformation unit 10, the reference point generation unit 20, the calculation unit 30, the interpolation formula generation unit 40, and the interpolation processing unit 50) of the signal processing apparatus 1. The processor 1020 reads and executes the program modules on the memory 1030, thereby enabling the functions related to the program modules. The storage device 1040 may function as the storage unit 2 connected to the signal processing apparatus 1.

The input/output interface 1050 is an interface for connecting the signal processing apparatus 1 and various input/output devices.

The network interface 1060 is an interface for connecting the signal processing apparatus 1 to a network. The network is, for example, a local area network (LAN) or a wide area network (WAN). A method of connecting the network interface 1060 to the network may be a wireless connection or a wired connection. The signal processing apparatus 1 may communicate with the artificial satellite 5 via the network interface 1060.

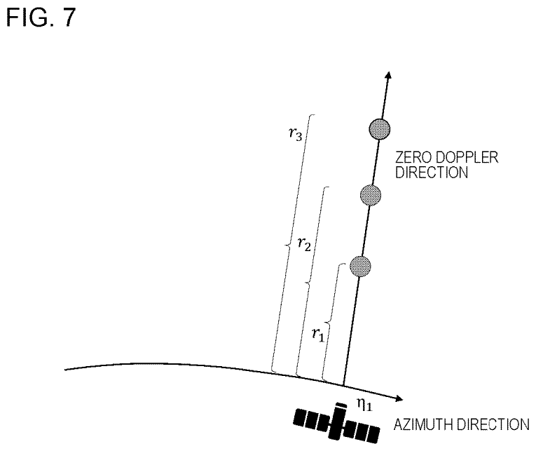

FIG. 7 is a diagram illustrating a conventional method of generating a plurality of reference points. Conventionally, a reference point has been generated in the zero Doppler direction, but when the squint angle increases (for example, 5 degrees or more), there has been a problem that imaging performance deteriorates.

In the signal processing apparatus 1 according to the first example embodiment, the reference point F is generated based on the new coordinate system (ξ-r system) in consideration of the squint angle, whereby it is possible to improve the imaging performance when a SAR image is generated.

That is, according to this signal processing apparatus, it is possible to obtain the signal processing apparatus 1 capable of improving the imaging performance.

### Second Example Embodiment

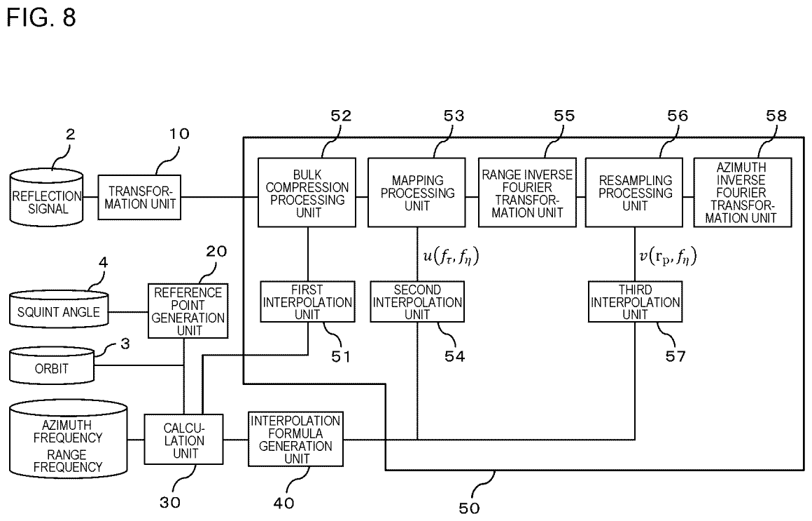

FIG. 8 is a block diagram illustrating an outline of a signal processing apparatus 1 according to a second example embodiment. The signal processing apparatus 1 according to the second example embodiment is different from the first example embodiment in processing of a reference point generation unit 20, a calculation unit 30, an interpolation formula generation unit 40, and an interpolation processing unit 50.

The calculation unit 30 according to the second example embodiment calculates each phase of second signal data related to a reference point F by further using orbit data of an artificial satellite 5, data regarding the interval of an azimuth frequency, and data regarding the interval of a range frequency. The orbit data of the artificial satellite 5 is data regarding the orbit of the artificial satellite 5, and includes, for example, data regarding the position of the artificial satellite 5 from the earth, and data regarding the velocity vector of the artificial satellite 5 (the magnitude and direction of the velocity of the artificial satellite 5). The orbit data of the artificial satellite 5 may be stored in a storage unit 3 or may be acquired from the artificial satellite 5.

The data regarding the interval of the azimuth frequency is data regarding how long interval the data is acquired with respect to the azimuth frequency axis (see the horizontal axis in the right diagram of FIG. 3). For example, in the case of an interval of 100 [Hz], the phase of the second signal data is calculated at an interval of 100 [Hz] with respect to the azimuth frequency axis with respect to a certain reference point F. The data regarding the interval of the azimuth frequency may be predetermined by the user.

The data regarding the interval of the range frequency is data regarding how long interval the data is acquired with respect to the range frequency axis (see the vertical axis in the right diagram of FIG. 3). For example, in the case of an interval of 10,000 [Hz], the phase of the second signal data is calculated at an interval of 10,000 [Hz] with respect to the range frequency axis for a certain reference point F. The data regarding the interval of the range frequency may be predetermined by the user.

The interpolation processing unit 50 according to the second example embodiment includes a bulk compression processing unit 52 that executes a bulk compression process, a mapping processing unit 53 that executes a mapping process, and a resampling processing unit 56 that executes a resampling process. Details of each process will be described later.

### (Flow of Interpolation Formula Generation)

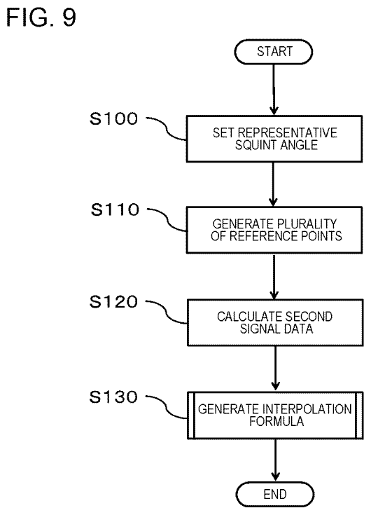

FIG. 9 is a flowchart until the interpolation formula generation unit 40 generates an interpolation formula. Processing in which the interpolation formula generation unit 40 generates an interpolation formula will be described with reference to FIG. 9.

In Step S100, the reference point generation unit 20 acquires information regarding the representative squint angle from a storage unit 4. The reference point generation unit 20 may acquire information regarding the representative squint angle from the artificial satellite 5. As a method of determining the representative squint angle, for example, the squint angle at the time when the antenna is most directed among the squint angles of the artificial satellite 5 may be used as the representative squint angle. As another example, in an image capturing format (strip map mode) in which the squint angle does not change at all during imaging, it is desirable to use the squint angle at that time. As still another example, in a mode (called a spotlight mode or the like) in which an image is captured while slightly moving the antenna (about 1 to 2 degrees), it is desirable to set the angle of the antenna at the center of a range in which the antenna moves, as the representative squint angle.

In Step S110, the reference point generation unit 20 generates a plurality of reference points in the range direction DR3 (=emission direction DR3) by using the acquired representative squint angle. The reference point generation unit 20 generates a plurality of reference points in the ξ-r system.

In Step S120, the calculation unit 30 calculates the phase of the second signal data (two-dimensional spectrum) in the frequency domain for each reference point F.

In Step S130, the interpolation formula generation unit 40 generates an interpolation formula by using the phase of each piece of the second signal data calculated by the calculation unit 30. Details of an interpolation formula generation method will be described in the following flow.

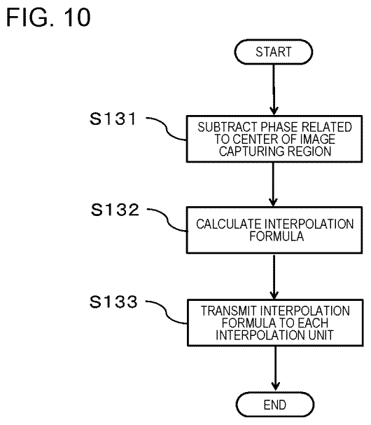

FIG. 10 is a flowchart illustrating details of the interpolation formula generation method. Processing of generating an interpolation formula will be described with reference to FIG. 10. As a premise, it is assumed that a formula having a relation as follows is obtained.

$$\begin{matrix}[ Math . 1 ] & \\ ψ ( {f}_{τ} , {f}_{η} , {r}_{p} , {η}_{p} ) = ψ ( {f}_{τ} , {f}_{η} , {r}_{c} , {η}_{c} ) - 2 π u ( {f}_{τ} , {f}_{η} ) v ( {r}_{p} , {f}_{η} ) - 2 {π f}_{η} ( {η}_{p} , {η}_{c} ) & ( 1 )\end{matrix}$$

The left side of Formula (1) is a relational formula related to the phase of the second signal data (two-dimensional spectrum). Data regarding the phase of the second signal data for each reference point F, which has been calculated by the calculation unit 30, is calculated by using the interval of the azimuth frequency and the interval of the range frequency determined by the data regarding the interval of the azimuth frequency and the data regarding the interval of the range frequency. A relational formula related to the phase of the second signal data is expressed by Formula (2).

$$\begin{matrix}[ Math . 2 ] & \\ ψ ( {f}_{τ} , {f}_{η} , {r}_{p} , {η}_{p} ) & ( 2 )\end{matrix}$$

f_{τ} is a range frequency for a certain reference point F, f_{η} is an azimuth frequency for a certain reference point F, rₚ is a range for a certain reference point F, and ηₚ is an azimuth time (=beam passage azimuth time) for a certain reference point F. The coordinate system is defined by the ξ-r system.

In Step S131, the interpolation formula generation unit 40 subtracts a phase related to the center of the image capturing region R from the phase of the second signal data. The phase related to the center of the image capturing region R is the phase of the second signal data in a case where the reference point F is set at the center of the image capturing region R. The phase related to the center of the image capturing region R is the first term on the right side of Formula (1), and is expressed by Formula (3). Formula (3) is the phase itself calculated by the calculation unit 30 for a point corresponding to the center of the reference point F. The phase is calculated using the azimuth frequency and the range frequency determined by the data regarding the interval of the azimuth frequency and the data regarding the interval of the range frequency. Formula (3) is also a term based on the phase of the second signal data when the radar is virtually emitted to the reference point F disposed at the center of the image capturing region R.

$$\begin{matrix}[ Math . 3 ] & \\ ψ ( {f}_{τ} , {f}_{η} , {r}_{c} , {η}_{c} ) & ( 3 )\end{matrix}$$

r_{c} is a range for the reference point F provided at the center of the image capturing region R, and η_{c} is an azimuth time (=beam passage azimuth time azimuth time) for the reference point F provided at the center of the image capturing region R. All the reference points are arranged in different ranges rₚ on the azimuth time of η_{c} (=beam passage azimuth time) in the ξ-r system (see FIG. 5).

In Step S131, a process of subtracting Formula (3) from Formula (2) is executed. That is, each of the phases at the range frequency and the azimuth frequency calculated by the calculation unit 30 for the reference point F at the center of the image capturing region R is subtracted from each of the phases at the range frequency and the azimuth frequency calculated by the calculation unit 30 for each of the reference points F. At this time, in the ξ-r system, since η_{c} and ηₚ are equal for each reference point F, the term related to a difference between η_{c} and ηₚ in Formula (1) (2πfₙ(ηₚ−η_{c})) can be ignored in Step S132 which will be described later. The third term (2πf_{η}(ηₚ−η_{c}) on the right side of Formula (1) is also a term based on a phase representing a shift in the traveling direction DR1 with respect to each of the plurality of reference points F.

In Step S132, the interpolation formula generation unit 40 calculates an interpolation formula that can be represented by the following Formula (4), by using the subtraction result obtained in Step S131. rₚ in Formula (4) represents the range.

$$\begin{matrix}[ Math . 4 ] & \\ - 2 π u ( {f}_{τ} , {f}_{η} ) v ( {r}_{p} , {f}_{η} ) & ( 4 )\end{matrix}$$

A function represented by u(f_{τ}, f_{η}) in Formula (4) is expressed by Formula (5). Formula (5) is a function that depends only on the range frequency f_{τ} with respect to each azimuth frequency f_{η}.

$$\begin{matrix}[ Math . 5 ] & \\ u ( {f}_{τ} , {f}_{η} ) & ( 5 )\end{matrix}$$

A function represented by v(rₚ, f_{η}) in Formula (4) is expressed by Formula (6). Formula (6) is a function that depends only on a distance (In this case, the range r) between the artificial satellite 5 and the reference point F for each azimuth frequency f_{η}.

$$\begin{matrix}[ Math . 6 ] & \\ v ( {r}_{p} , {f}_{η} ) & ( 6 )\end{matrix}$$

In Step S133, the interpolation formula generation unit 40 transmits information (interpolation formula) regarding the function represented by Formula (5) to a second interpolation unit 54, and transmits information (interpolation formula) regarding the function represented by Formula (6) to a third interpolation unit 57.

The second interpolation unit 54 transmits information regarding the function represented by Formula (5) to the mapping processing unit 53 which will be described later. The third interpolation unit 57 transmits information regarding the function represented by Formula (6) to the resampling processing unit 56 which will be described later.

A first interpolation unit 51 acquires, from the calculation unit 30, data regarding the phase of the second signal data at the reference point F provided at the center of the image capturing region R calculated by the calculation unit 30, and transmits the data to the bulk compression processing unit 52. The data regarding the phase of the second signal data is the same as the data subtracted in Step S131 (=Formula (3)). Since the data regarding the phase of the second signal data acquired above is discrete on the azimuth frequency axis and the range frequency axis, the first interpolation unit 51 performs interpolation processing on the azimuth frequency axis and the range frequency axis and then transmits a result of the interpolation processing to the bulk compression processing unit 52.

In the interpolation formula generation flow described above, each interpolation formula may be calculated with reference to, for example, the SVD-STOLT method disclosed in NPL 2. In the present example embodiment, when the interpolation formula is generated, a part in which the process of generating the interpolation formula is executed in not the conventional η-p system but the ξ-r system is a new part.

### (Flow of SAR Image Generation)

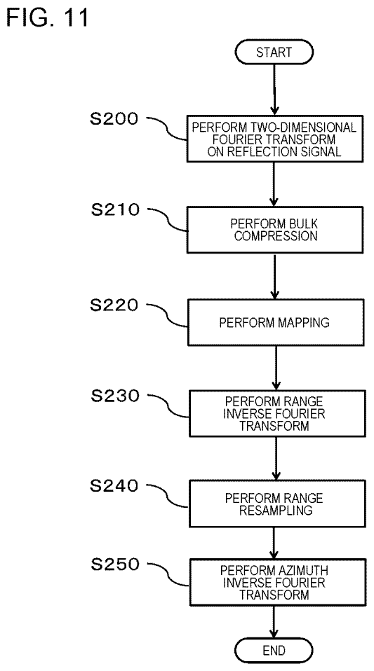

FIG. 11 is a flowchart up to generation of a SAR image. Processing up to generation of the SAR image will be described with reference to FIG. 11.

In Step S200, the transformation unit 10 performs two-dimensional Fourier transform on a reflection signal from a scatterer N into first signal data in the frequency domain.

In Step S210, the bulk compression processing unit 52 executes the bulk compression process on the first signal data by using the data regarding the phase of the second signal data at the reference point F interpolated by the first interpolation unit 51. The bulk compression process is similar to Reference function multiplication (bulk compression) disclosed in NPL 1.

The bulk compression process will be described in more detail. The bulk compression processing unit 52 multiplies the first signal data generated by two-dimensional Fourier transform by the transformation unit 10 by a reference signal. The reference signal is a complex conjugate after Fourier transform of an ideal response (range time) from the scatterer N in a case where the scatterer N exists at the reference point F (reference point provided at the center of the image capturing region R). The reference signal is obtained as a complex number having an absolute value of 1 and having a phase obtained by adding a negative sign to the phase obtained from the first interpolation unit 51.

In Step S220, the mapping processing unit 53 executes the mapping process by using the information regarding the function represented by Formula (5), which has been received from the second interpolation unit 54. The mapping process is, for example, a process similar to “Stolt Interpolation” disclosed in NPL 2.

In Step S230, a range inverse Fourier transformation unit 55 performs (one-dimensional) inverse Fourier transform on the signal processed by the mapping processing unit 53 in the range direction.

In Step S240, the resampling processing unit 56 executes the resampling process. The resampling process is a process of changing the coordinate system. The resampling processing unit 56 resamples according to Formula (6) received from the third interpolation unit 57. That is, in the mapping process executed in Step S220, since mapping is performed in such a way that the expression (5) becomes the new range frequency, in the range inverse Fourier transform for the mapping result, the signal for rₚ exists at the position of v(rₚ, f_{η}) due to the definition of Formula (4) and the property of the shift of the Fourier transform. This is changed to rₚ by an inverse function of v in Formula (6). The resampling processing unit 56 executes the resampling process on the data generated by the range inverse Fourier transformation unit 55.

In Step S250, the azimuth inverse Fourier transformation unit 58 performs (one-dimensional) inverse Fourier transform on the data subjected to the resampling process in the azimuth direction DR1.

The data generated through Steps S200 to S250 is in a data format (see the left diagram of FIG. 3) in which the vertical axis represents the range time t and the horizontal axis represents the azimuth time n, and a SAR image is generated by collecting a large number of pieces of the data. Although the signal data is depicted in an elliptical shape in the left diagram of FIG. 3, the signal data is depicted in a dotted (or rectangular) shape through the processes of Steps S200 to S250.

The flows described with reference to FIGS. 9, 10, and 11 may be performed simultaneously or may be performed separately. The interpolation formula may be calculated in advance by performing the flow described with reference to FIGS. 9 and 10 in advance.

As described above, according to the signal processing apparatus 1 in the second example embodiment, the calculation unit 30 calculates each phase of the second signal data related to the reference point F by further using the orbit data of the artificial satellite 5, the data regarding the interval of the azimuth frequency, and the data regarding the interval of the range frequency. As a result, it is possible to accurately calculate the phase of the second signal data for each reference point F.

The interpolation processing unit 50 includes the bulk compression processing unit 52, the mapping processing unit 53, and the resampling processing unit 56. As a result, the interpolation processing unit 50 can perform the interpolation processing with high accuracy.

### Third Example Embodiment

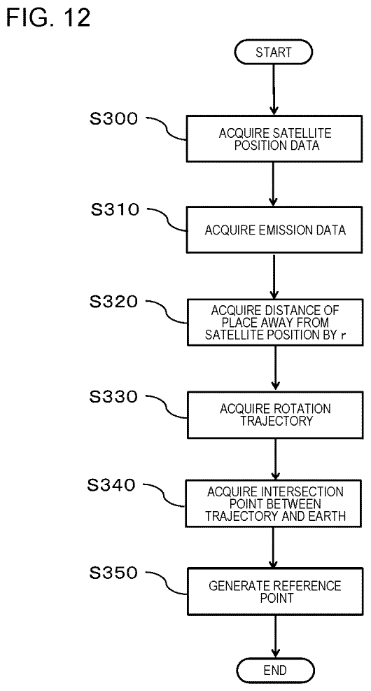

FIG. 12 is a flowchart when a reference point generation unit 20 according to a third example embodiment generates a reference point F. The processing of the reference point generation unit 20 in the signal processing apparatus 1 according to the third example embodiment is different from the processing of the reference point generation unit 20 according to the first example embodiment.

The reference point generation unit 20 according to the third example embodiment generates a plurality of reference points F by using position data regarding the position of the artificial satellite 5, emission data regarding the emission direction DR3, and the topographical data. The position data regarding the position of the artificial satellite 5, the emission data regarding the emission direction DR3, and the topographical data will be described later.

Processing in which the reference point generation unit 20 according to the third example embodiment generates the reference point F will be described below with reference to FIG. 12.

In Step S300, the reference point generation unit 20 acquires position data regarding the position of the artificial satellite 5 from the artificial satellite 5 (may also acquire the position data from the storage unit). The position data includes a beam passage azimuth time ξₚ when the radar of the artificial satellite 5 is emitted to a representative point (for example, the center point of the image capturing region R) in the image capturing region R, and position information (the position information of the artificial satellite 5 with respect to the earth and the earth center fixed coordinate system are preferable) of the artificial satellite 5 at the beam passage azimuth time ξₚ.

In Step S310, the reference point generation unit 20 acquires the emission data regarding the emission direction DR3 from the artificial satellite 5. The emission data includes information regarding the direction in which the antenna of the artificial satellite 5 is directed and information regarding the squint angle θ_{sq}.

In Step S320, the reference point generation unit 20 acquires position information (position information in a geographical space) of a place away from the position of the artificial satellite 5 by r [km] in the range direction DR3 (emission direction DR3) in the ξ-r system. r [km] is a distance given as a place where the reference point is placed. The user may designate r [km] in advance.

In Step S330, the reference point generation unit 20 acquires a trajectory when a place away by r [km] is rotated about a straight line that is parallel to the azimuth direction DR1 (=traveling direction DR1) at the beam passage azimuth time ξₚ and passes through the position of the satellite at the beam passage azimuth time ξₚ as an axis.

In Step S340, the reference point generation unit 20 acquires position information at an intersection point between the rotated trajectory and the earth by using the topographical data. The reference point generation unit 20 acquires position information at an intersection point closer to the range direction DR3 among a plurality of acquired intersection points. The topographical data includes data regarding terrain on the earth, and the data regarding the terrain includes coordinate data on a three-dimensional space of irregularities (including buildings, mountains, and the like) on the earth's surface.

In Step S350, the reference point generation unit 20 generates the position (position in the three-dimensional space) at the intersection point acquired in Step S340, as the reference point F at the distance r.

According to the third example embodiment, the reference point generation unit 20 generates a plurality of reference points F by using the position data regarding the position of the artificial satellite 5, the emission data regarding the emission direction DR3, and the topographical data. As a result, it is possible to generate the reference point F in consideration of the influence of the actual topography of the ground surface (presence or absence of irregularities and the like), the curvature of the earth, and the like. Therefore, it is possible to improve the imaging accuracy.

### Fourth Example Embodiment

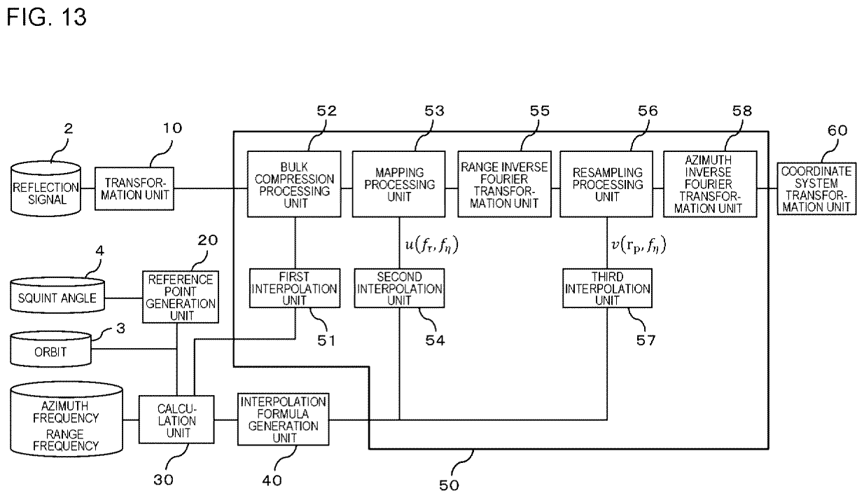

FIG. 13 is a block diagram illustrating an outline of a signal processing apparatus 1 according to a fourth example embodiment. Unlike the signal processing apparatus 1 according to the second example embodiment, the signal processing apparatus 1 according to the fourth example embodiment further includes a coordinate system transformation unit 60.

The coordinate system transformation unit 60 acquires third signal data from an interpolation processing unit 50. The third signal data is data based on a first coordinate system among pieces of data obtained by performing inverse Fourier transform on the first signal data by the interpolation processing unit 50 (through a predetermined process such as the bulk compression process). The third signal data is data based on the first coordinate system among pieces of data finally obtained in a manner that the azimuth inverse Fourier transformation unit 58 performs one-dimensional inverse Fourier transform in the processing of the interpolation processing unit 50.

The first coordinate system is the ξ-r system. That is, in the first coordinate system, one axis represents the distance (=range) from the artificial satellite 5 to the scatterer in the emission direction DR3 (=range direction DR3), and the other axis represents the time (=beam passage azimuth time) when the center of the radar emitted by the satellite 5 passes through the scatterer N.

The coordinate system transformation unit 60 transforms third signal data into fourth signal data. The fourth signal data is data based on a second coordinate system different from the first coordinate system. The fourth signal data is data obtained by transforming the coordinate system of the third signal data. The second coordinate system is an η-ρ system. That is, in the second coordinate system, one axis is an axis representing the distance (zero Doppler range ρ) from the artificial satellite 5 to the scatterer N in the vertical direction DR2 (=zero Doppler direction DR2), and the other axis is represented by the time (=nearest time) when the distance between the artificial satellite 5 and the scatterer N is shortest. The coordinate system transformation unit 60 transforms the ξ-r system into the η-p system for the third signal data.

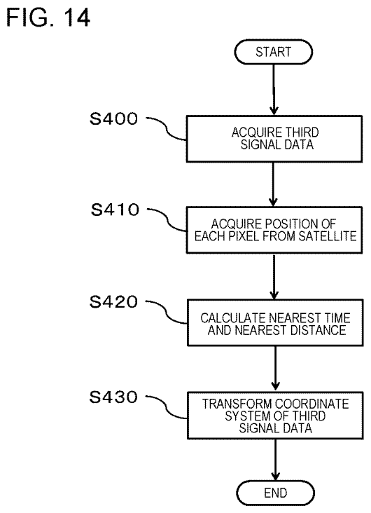

FIG. 14 is a flowchart illustrating processing of the coordinate system transformation unit 60 according to the fourth example embodiment. The processing of the coordinate system transformation unit 60 will be described in detail with reference to FIG. 14. As a premise, it is assumed that the imaging result and the squint angle in the ξ-r system are known.

In Step S400, the coordinate system transformation unit 60 acquires third signal data from the interpolation processing unit 50 (=an azimuth inverse Fourier transformation unit 58).

In Step S410, the coordinate system transformation unit 60 acquires each piece of pixel data associated with the third signal data, and acquires each piece of position information (ξ-r system) of the artificial satellite 5 in each piece of pixel data. The position information of the artificial satellite 5 in the pixel data is information regarding a distance (range) between the scatterer N related to the pixel data and the artificial satellite 5.

In Step S420, the coordinate system transformation unit 60 calculates the nearest distance and the nearest time ηₚ between each piece of pixel data and the artificial satellite 5. The nearest distance is a distance when the scatterer N related to certain piece of pixel data and the artificial satellite 5 are nearest to each other. That is, the nearest distance is a distance from the artificial satellite 5 to the scatterer N in the η-ρ system, and is also the zero Doppler range ρ. The nearest distance is also the distance from the artificial satellite 5 to the scatterer N at the nearest time ηₚ. The nearest time ηₚ is also a time when the artificial satellite 5 is at the nearest distance.

In Step S430, the coordinate system transformation unit 60 transforms the coordinate system of the third signal data into the fourth signal data based on the second coordinate system. The coordinate system transformation unit 60 performs data transformation with the axis related to the nearest time ηₚ calculated in Step S420 as an azimuth axis and the axis related to the nearest distance as a range axis. In this manner, the coordinate system transformation unit 60 transforms the ξ-r system related to the third signal data into the η-p system.

The SAR image generation unit (not illustrated) may generate the SAR image by using the fourth signal data subjected to the coordinate transformation by the coordinate system transformation unit 60.

As described above, the signal processing apparatus 1 according to the fourth example embodiment further includes the coordinate system transformation unit 60. By returning to the conventional coordinate system and then performing imaging, the conventional imaging method can be used as it is. Therefore, it is possible to easily generate the SAR image.

### Fifth Example Embodiment

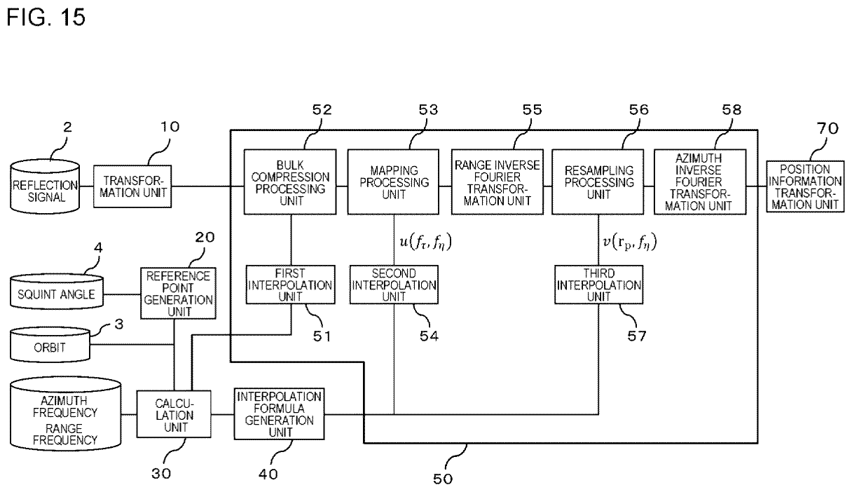

FIG. 15 is a block diagram illustrating an outline of a signal processing apparatus 1 according to a fifth example embodiment. Unlike the signal processing apparatus 1 according to the second example embodiment, the signal processing apparatus 1 according to the fifth example embodiment further includes a position information transformation unit 70.

The position information transformation unit 70 transforms the position information of pixel data associated with data obtained by performing the inverse Fourier transform on the first signal data by the interpolation processing unit 50 into the position information on the earth. The pixel data includes the position information. The position information includes information regarding the distance r between the scatterer N related to the pixel data and the artificial satellite 5.

The data obtained by performing the inverse Fourier transform on the first signal data by the interpolation processing unit 50 may be the third signal data according to the fourth example embodiment. The data obtained by performing the inverse Fourier transform on the first signal data by the interpolation processing unit 50 is handled as the third signal data below.

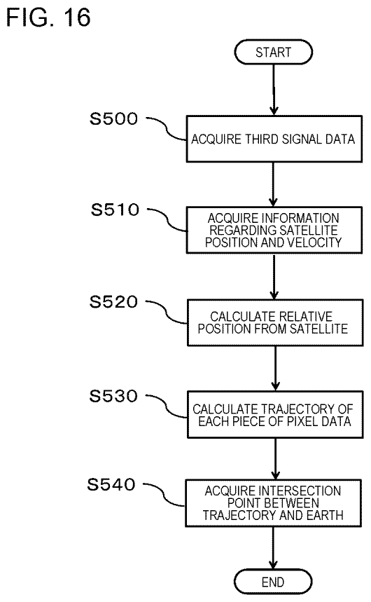

FIG. 16 is a flowchart illustrating processing of the position information transformation unit 70 according to the fifth example embodiment. The processing of the position information transformation unit 70 will be described in detail with reference to FIG. 16. As a premise, it is assumed that the imaging result, the orbit data, the topographical data, and the squint angle in the ξ-r system are known.

In Step S500, the position information transformation unit 70 acquires third signal data from the interpolation processing unit 50 (=an azimuth inverse Fourier transformation unit 58).

In Step S510, the position information transformation unit 70 acquires information regarding the position of the artificial satellite 5 at the beam passage azimuth time ξₚ and information regarding the velocity of the artificial satellite 5 (velocity vector), which are related to each piece of pixel data in the ξ-r system. The position information transformation unit 70 may acquire the information regarding the position of the artificial satellite 5 and the information regarding the velocity of the artificial satellite 5 from the orbit data stored in the storage unit 3, or may directly acquire the information from the artificial satellite 5.

In Step S520, the position information transformation unit 70 calculates the relative position from the position of the artificial satellite 5 for each pixel data by using the range r.

In Step S530, the position information transformation unit 70 rotates a place related to each piece of pixel data (the radius of rotation is the range r) about a straight line that is parallel to the velocity vector of the artificial satellite 5 at the beam passage azimuth time ξₚ and passes through the azimuth position of the artificial satellite 5 as an axis, and calculates a trajectory depicted by the place related to each piece of pixel data.

In Step S540, the position information transformation unit 70 sets a point at which the trajectory intersects with the earth as the ground position of the pixel data. The position data of the earth's surface may be extracted from the topographical data according to the third example embodiment. In this manner, the position information transformation unit 70 transforms the position information of the pixel data associated with the third signal data into the position information on the earth.

As described above, the signal processing apparatus 1 according to the fifth example embodiment further includes the position information transformation unit 70. Unlike the fourth example embodiment, the position information of the pixel data can be directly transformed into the position information on the earth without passing through the processing of transforming the ξ-r system into the η-ρ system. As a result, it is possible to easily generate a SAR image.

### Sixth Example Embodiment

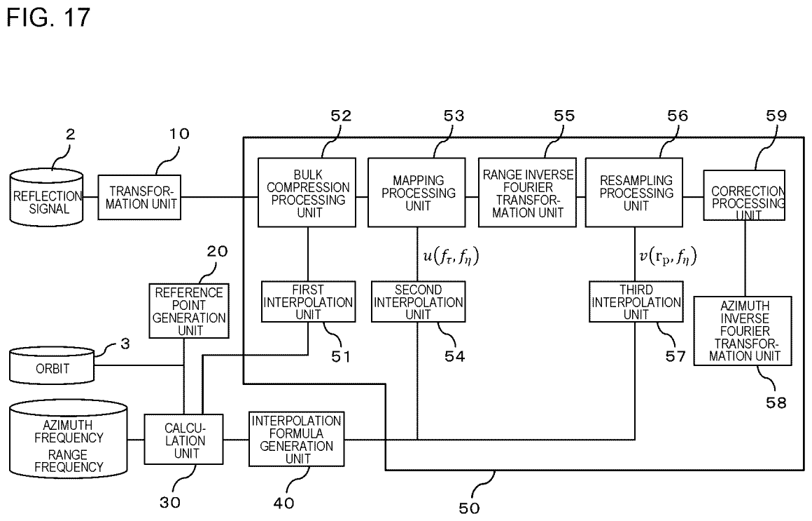

FIG. 17 is a block diagram illustrating an outline of a signal processing apparatus 1 according to a sixth example embodiment. Unlike the second example embodiment, an interpolation processing unit 50 according to the sixth example embodiment includes a correction processing unit 59, and the processing of a reference point generation unit 20 and an interpolation formula generation unit 40 is different from the second example embodiment.

The reference point generation unit 20 according to the sixth example embodiment does not generate a plurality of reference points in the ξ-r system. The reference point generation unit 20 may generate a plurality of reference points in the η-p system.

The interpolation formula generation unit 40 generates an interpolation formula by using a term based on a phase related to the center frequency f_{c} of radar emitted from the artificial satellite 5. The phase related to the center frequency f_{c} is a phase of a part associated with the center frequency f_{c} in the phase of the second signal data in the frequency domain with respect to the reference point F. The center frequency f_{c} is a center frequency of a frequency band of the radar (electromagnetic waves) emitted by the artificial satellite 5. Specific processing will be described later.

A correction processing unit 59 performs correction processing of correcting an influence caused by the term based on the phase related to the center frequency f_{c}. Specific processing will be described later.

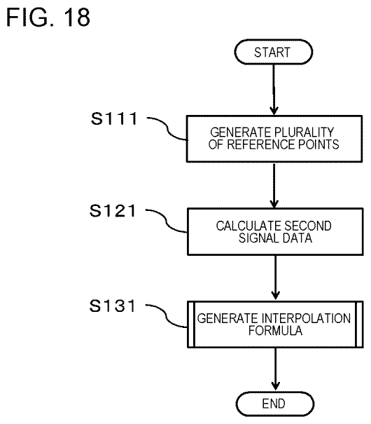

FIG. 18 is a flowchart until the interpolation formula generation unit 40 according to the sixth example embodiment generates an interpolation formula. Processing in which the interpolation formula generation unit 40 according to the sixth example embodiment generates an interpolation formula will be described with reference to FIG. 18.

In Step S111, the reference point generation unit 20 generates a plurality of reference points. In the sixth example embodiment, the reference point generation unit 20 generates a plurality of reference points in the η-p system.

In Step S121, the calculation unit 30 calculates the phase of the second signal data (two-dimensional spectrum) in the frequency domain for each reference point F.

In Step S131, the interpolation formula generation unit 40 generates an interpolation formula by using the phase of each piece of the second signal data calculated by the calculation unit 30. Details of an interpolation formula generation method will be described in the following flow.

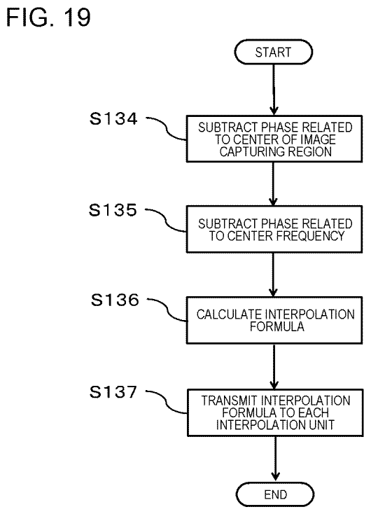

FIG. 19 is a flowchart illustrating details of an interpolation formula generation method according to the sixth example embodiment. Processing of generating an interpolation formula according to the sixth example embodiment will be described in detail with reference to FIG. 19.

In a case where the interpolation formula is generated by the η-p system, it may be difficult to accurately calculate the interpolation formula (Formula (4)) (although the accuracy of Formula (1) is not favorable first, the accuracy of Formula (1) is particularly poor in the case of high squint). Therefore, the inventor has made a close study and has found that the accuracy of the interpolation formula can be improved by adding a term based on the phase related to the center frequency f_{c} to Formula (1) (at least for f_{τ}-f_{c}, an idea of u(f_{τ}, f_{η})=v(rₚ, f_{η})=0). A formula obtained by adding the term based on the phase related to the center frequency f_{c} to Formula (1) is represented as follows.

$$\begin{matrix}[ Math . 7 ] & \\ ψ ( {f}_{τ} , {f}_{η} , {r}_{p} , {η}_{p} ) = ψ ( {f}_{τ} , {f}_{η} , {r}_{c} , {η}_{c} ) + ( ψ ( {f}_{c} , {f}_{η} , {r}_{p} , {η}_{c} ) - ψ ( {f}_{c} , {f}_{η} , {r}_{c} , {η}_{c} ) ) - 2 π u ( {f}_{τ} , {f}_{η} ) v ( {r}_{p} , {f}_{η} ) - 2 {π f}_{η} ( {η}_{p} , {η}_{c} ) & ( 7 )\end{matrix}$$

The following description is based on the premise that Formula (7) has been found. The coordinate system is an η-ρ system. The interpolation formula is generated by using Formula (7). The interpolation formula is represented by the sum of a term based on the phase of the second signal data when the radar is virtually emitted to the reference point F disposed at the center of the image capturing region R, a term based on the phase related to the center frequency f_{c}, a term based on the phase represented as a product of a function depending only on the range frequency for each azimuth frequency and a function depending only on the distance (in this case, the zero Doppler range ρ) between the artificial satellite 5 and the reference point F, and a term based on the phase representing a shift of each of the plurality of reference points F in the traveling direction DR1. The interpolation formula is generated using a formula (see Formula (7)) that matches a term based on the phase of the second signal data for each of the plurality of reference points F.

The left side of Formula (7) is a relational formula related to the phase of the second signal data (two-dimensional spectrum), and is similar to Formula (2). The left side of Formula (7) is a term based on the phase of the second signal data for each of the plurality of reference points F.

$$\begin{matrix}[ Math . 8 ] & \\ ( ψ ( {f}_{c} , {f}_{η} , {r}_{p} , {η}_{c} ) - ψ ( {f}_{c} , {f}_{η} , {r}_{c} , {η}_{c} ) ) & ( 8 )\end{matrix}$$

In Step S134, the interpolation formula generation unit 40 subtracts the phase related to the center of the image capturing region R from the phase of the second signal data. The phase related to the center of the image capturing region R is the phase of the second signal data in a case where the reference point F is set at the center of the image capturing region R. The phase related to the center of the image capturing region R is the first term on the right side of Formula (7), and is the same as Formula (3). In Step S134, a process of subtracting Formula (3) from Formula (2) is executed. Formula (3) is the term based on the phase of the second signal data when the radar is virtually emitted to the reference point F disposed at the center of the image capturing region R.

$$\begin{matrix}[ Math . 9 ] & \\ - 2 π u ( {f}_{τ} , {f}_{η} ) v ( {r}_{p} , {f}_{η} ) & ( 9 )\end{matrix}$$

In Step S135, the interpolation formula generation unit 40 further subtracts the phase related to the center frequency f_{c} from the relational formula obtained by subtracting Formula (3) from Formula (2). The term based on the phase related to the center frequency f_{c} is the second term on the right side of Formula (7) and is represented expressed as Formula (8). The term (Formula (8)) based on the phase related to the center frequency f_{c} is a term based on a difference between the phase of reflection signal data obtained when the radar (the radar having only the center frequency f_{c}) at the center frequency f_{c} is virtually emitted to the reference point F disposed at the position different from the center of the image capturing region R of the artificial satellite 5 and the phase of reflection signal data obtained when the radar at the center frequency f_{c} is virtually emitted to the reference point F disposed at the center of the image capturing region R.

$$\begin{matrix}[ Math . 10 ] & \\ exp ( - j ( ψ ( {f}_{c} , {f}_{η} , {r}_{p} , {η}_{c} ) - ψ ( {f}_{c} , {f}_{η} , {r}_{c} , {η}_{c} ) ) ) & ( 10 )\end{matrix}$$

In Step S136, the interpolation formula generation unit 40 calculates an interpolation formula that can be represented by the following Formula (9), by using the data regarding the phase of the second signal data with respect to each reference point F calculated by the calculation unit 30 (and the relational formula described above). rₚ in Formula (9) represents the zero Doppler range ρ. Formula (9) is a term based on a phase represented as a product of a function (function of u) depending only on the range frequency and a function (function of v) depending only on the distance (zero Doppler range p) between the artificial satellite 5 and the reference point F, for each azimuth frequency.

$$\begin{matrix}[ Math . 11 ] & \\ - 2 π u ( {f}_{τ} , {f}_{η} ) v ( {r}_{p} , {f}_{η} ) & ( 9 )\end{matrix}$$

The process of transmitting the function represented by u(f_{τ}, f_{η}) and the function represented by v(rₚ, f_{η}) to each interpolation unit after generating the interpolation formula (9) is the same as that in the second example embodiment.

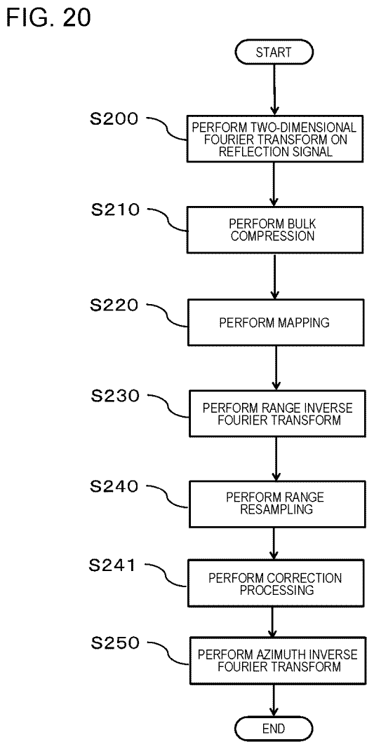

FIG. 20 is a flowchart up to generation of a SAR image in the sixth example embodiment. Processing up to generation of a SAR image in the sixth example embodiment will be described with reference to FIG. 20.

The sixth example embodiment is different from the second example embodiment in that there is correction processing by a correction processing unit 59. Since the processes of Step S200, Step S210, Step S220, Step S230, Step S240, and Step S250 are similar to those of the second example embodiment, the description will be omitted.

In the sixth example embodiment, in Step S241 between Step S240 and Step S250, the correction processing unit 59 performs correction processing of correcting the influence caused by the term based on the phase related to the center frequency f_{c}. The correction processing is similar to “azimuth focusing” disclosed in NPL 3. More specifically, the correction processing unit 59 corrects the resampled data by multiplying the resampled data by the following Formula (10).

$$\begin{matrix}[ Math . 12 ] & \\ exp ( - j ( ψ ( {f}_{c} , {f}_{η} , {r}_{p} , {η}_{c} ) - ψ ( {f}_{c} , {f}_{η} , {r}_{c} , {η}_{c} ) ) ) & ( 10 )\end{matrix}$$

In the present example embodiment, when the interpolation formula is generated, a part at which a new relational formula is generated by adding the term based on the phase related to the center frequency f_{c} to Formula (1) is a new part.

In the signal processing apparatus 1 according to the sixth example embodiment, the accuracy of the interpolation formula is improved by considering the term based on the phase related to the center frequency f_{c}. As a result, it is possible to improve the imaging performance when the SAR image is generated.

In the sixth example embodiment, the signal processing apparatus 1 can be achieved with the configuration illustrated in FIG. 4. The first interpolation unit 51, the bulk compression processing unit 52, the mapping processing unit 53, the second interpolation unit 54, the range inverse Fourier transformation unit 55, the resampling processing unit 56, the third interpolation unit 57, the azimuth inverse Fourier transformation unit 58, and the correction processing unit 59 are merely examples of the configuration of the interpolation processing unit 50.

In the sixth example embodiment, in a case where the signal processing apparatus 1 is achieved as illustrated in FIG. 4, the functions of the transformation unit 10 and the calculation unit 30 are similar to those of the first example embodiment. The reference point generation unit 20 generates a plurality of reference points, but does not generate a reference point in the g-r system unlike the first example embodiment. The interpolation formula generation unit 40 is different from the first example embodiment in that the interpolation formula is generated using the term based on the phase related to the center frequency f_{c}. The interpolation processing unit 50 (correction processing unit 59) is different from that of the first example embodiment in that the interpolation processing unit 50 performs correction processing of correcting the influence caused by the term based on the phase related to the center frequency f_{c}.

### Seventh Example Embodiment

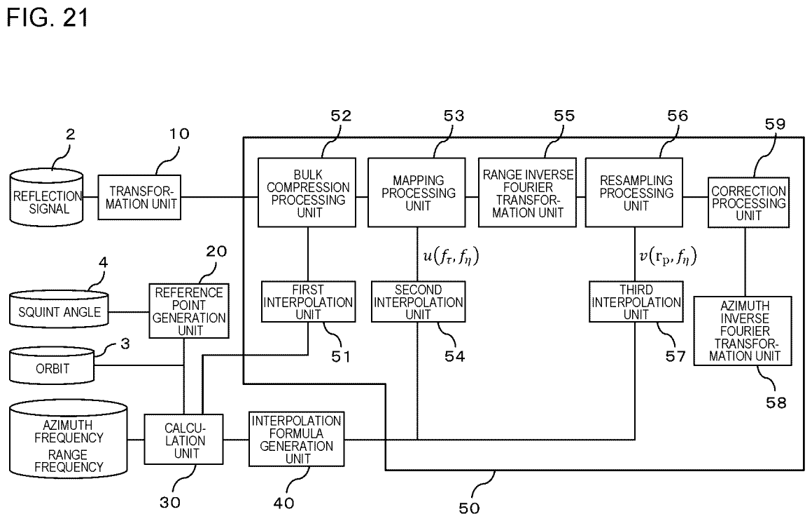

FIG. 21 is a block diagram illustrating an outline of a signal processing apparatus 1 according to a seventh example embodiment. The processing of the reference point generation unit 20 according to the seventh example embodiment is different from that of the sixth example embodiment.

As in the first example embodiment, the reference point generation unit 20 according to the seventh example embodiment generates a plurality of reference points in a direction obliquely inclined with respect to the vertical direction DR2 perpendicular to the traveling direction DR1 in the plane P defined by the traveling direction DR1 and the emission direction DR3. The obliquely inclined direction may be the emission direction DR3. The reference point generation unit 20 according to the seventh example embodiment generates a plurality of reference points in the g-r system.

The signal processing apparatus 1 according to the seventh example embodiment also has the same operations and effects as those of the first example embodiment, the second example embodiment, and the sixth example embodiment.

Although the example embodiments of the present invention have been described above with reference to the drawings, these are examples of the present invention, and various configurations other than the above description can be adopted.

The signal processing apparatus 1 may be achieved by one computer. The signal processing apparatus 1 may be achieved by freely mounting the functions (the transformation unit 10, the reference point generation unit 20, the calculation unit 30, the interpolation formula generation unit 40, and the interpolation processing unit 50) of the signal processing apparatus 1 on a plurality of computers.

The configurations according to the third to fifth example embodiments may be applied to the sixth and seventh example embodiments.

In the fourth example embodiment, in a case where the orbit of the artificial satellite 5 does not largely deviate from the straight line, a value obtained by multiplying the distance r from the artificial satellite 5 to the pixel data by cos θ may be used as the range in the SAR image, and a value obtained by multiplying the distance r by sine and dividing the result by the satellite traveling speed may be used as the azimuth time in the SAR image.

In the plurality of flowcharts used in the above description, a plurality of steps (processes) is described in order, but the execution order of the steps executed in each example embodiment is not limited to the described order. In each example embodiment, the order of the illustrated steps can be changed as long as there is no problem in terms of content. The above-described example embodiments can be combined within a range in which the contents are not contradictory.

Some or all of the above example embodiments may be described as the following Supplementary Notes, but are not limited to the following.

1. A signal processing apparatus including:
transformation means for performing Fourier transform on a reflection signal into first signal data in a frequency domain, the reflection signal representing reflection from a scatterer with respect to radar emitted from a flying object;
reference point generation means for generating a plurality of reference points arranged in a direction obliquely inclined with respect to a direction perpendicular to a traveling direction of the flying object in a plane defined by the traveling direction and an emission direction in which the flying object emits the radar;
calculation means for calculating each phase of second signal data in the frequency domain after Fourier transform on the reflection signal when the radar is virtually emitted to the plurality of reference points;
interpolation formula generation means for generating an interpolation formula by using each phase of the second signal data calculated by the calculation means; and
interpolation processing means for interpolating the first signal data transformed by the transformation means by using the interpolation formula, and performing inverse Fourier transform.

2. The signal processing apparatus described in 1, in which
the obliquely inclined direction is the emission direction.

3. The signal processing apparatus described in 2, further including:
coordinate system transformation means for acquiring third signal data based on a first coordinate system among pieces of data obtained in a manner that the interpolation processing means performs inverse Fourier transform on the first signal data, and transforming the third signal data into fourth signal data based on a second coordinate system different from the first coordinate system, in which
the first coordinate system has one axis representing a distance from the flying object to the scatterer in the emission direction, and the other axis representing a time when a center of the radar emitted by the flying object passes through the scatterer, and
the second coordinate system has one axis representing a distance from the flying object to the scatterer in the direction perpendicular to the traveling direction, and the other axis representing a time when the distance between the flying object and the scatterer is closest.

4. The signal processing apparatus described in 2 or 3, further including:
position information transformation means for transforming position information of pixel data associated with data obtained in a manner that the interpolation processing means performs inverse Fourier transform on the first signal data, into position information on the earth.

5. The signal processing apparatus described in any one of claims 2 to 4, in which
the reference point generation means generates the plurality of reference points by using position data related to a position of the flying object, emission data related to the emission direction, and topographical data.

6. The signal processing apparatus described in any one of claims 1 to 5, in which
the calculation means calculates each phase of the second signal data related to the reference point by further using trajectory data of the flying object, data regarding an interval of an azimuth frequency, and data regarding an interval of a range frequency.

7. The signal processing apparatus described in any one of 1 to 6, in which
the interpolation processing means includes bulk compression processing means for executing a bulk compression process, mapping processing means for executing a mapping process, and resampling processing means for executing a resampling process.

8. A signal processing method including:
by one or more computers,
performing Fourier transform on a reflection signal into first signal data in a frequency domain, the reflection signal representing reflection from a scatterer with respect to radar emitted from a flying object;
generating a plurality of reference points arranged in a direction obliquely inclined with respect to a direction perpendicular to a traveling direction of the flying object in a plane defined by the traveling direction and an emission direction in which the flying object emits the radar;
calculating each phase of second signal data in the frequency domain after Fourier transform on the reflection signal when the radar is virtually emitted to the plurality of reference points;
generating an interpolation formula by using each phase of the second signal data; and
interpolating the first signal data by using the interpolation formula, and performing inverse Fourier transform.

9. A program for causing a computer to execute:
a procedure of performing Fourier transform on a reflection signal into first signal data in a frequency domain, the reflection signal representing reflection from a scatterer with respect to radar emitted from a flying object;
a procedure of generating a plurality of reference points arranged in a direction obliquely inclined with respect to a direction perpendicular to a traveling direction of the flying object in a plane defined by the traveling direction and an emission direction in which the flying object emits the radar;
a procedure of calculating each phase of second signal data in the frequency domain after Fourier transform on the reflection signal when the radar is virtually emitted to the plurality of reference points;
a procedure of generating an interpolation formula by using each phase of the second signal data; and
a procedure of interpolating the first signal data by using the interpolation formula, and performing inverse Fourier transform.

This application is based upon and claims the benefit of priority from Japanese patent application No. 2023-002920, filed on Jan. 12, 2023, the disclosure of which is incorporated herein in its entirety by reference.

### REFERENCE SIGNS LIST

1 signal processing apparatus
2 storage unit
3 storage unit
4 storage unit
5 artificial satellite
10 transformation unit
20 reference point generation unit
30 calculation unit
40 interpolation formula generation unit
50 interpolation processing unit
60 coordinate system transformation unit
70 position information transformation unit
DR1 traveling direction (azimuth direction)
DR2 vertical direction (zero Doppler direction)
DR3 emission direction (range direction)
F reference point
R image capturing region

What is claimed is:

1. A signal processing apparatus comprising:
a memory configured to store instructions; and
a processor configured to execute the instructions to:
perform Fourier transform on a reflection signal into first signal data in a frequency domain, the reflection signal representing reflection from a scatterer with respect to radar emitted from a flying object;
generate a plurality of reference points arranged in a direction obliquely inclined with respect to a direction perpendicular to a traveling direction of the flying object in a plane defined by the traveling direction and an emission direction in which the flying object emits the radar;
calculate each phase of second signal data in the frequency domain after Fourier transform on the reflection signal when the radar is virtually emitted to the plurality of reference points;
generate an interpolation formula by using each phase of the second signal data calculated by the calculation means; and
interpolate the first signal data transformed by using the interpolation formula, and performing inverse Fourier transform.

2. The signal processing apparatus according to claim 1, wherein
the obliquely inclined direction is the emission direction.

3. The signal processing apparatus according to claim 2, wherein
the processor configured to further execute the instructions to:
acquire third signal data based on a first coordinate system among pieces of data obtained in a manner that the interpolation processing means performs inverse Fourier transform on the first signal data, and transforming the third signal data into fourth signal data based on a second coordinate system different from the first coordinate system, and
the first coordinate system has one axis representing a distance from the flying object to the scatterer in the emission direction, and the other axis representing a time when a center of the radar emitted by the flying object passes through the scatterer, and
the second coordinate system has one axis representing a distance from the flying object to the scatterer in the direction perpendicular to the traveling direction, and the other axis representing a time when the distance between the flying object and the scatterer is closest.

4. The signal processing apparatus according to claim 2, wherein
the processor configured to further execute the instructions to:
transform position information of pixel data associated with data obtained by performing inverse Fourier transform on the first signal data, into position information on the earth.

5. The signal processing apparatus according to claim 2, wherein
generating the plurality of reference points includes generating the plurality of reference points by using position data related to a position of the flying object, emission data related to the emission direction, and topographical data.

6. The signal processing apparatus according to claim 1, wherein
calculating each phase of the second signal data includes calculating each phase of the second signal data related to the reference point by further using trajectory data of the flying object, data regarding an interval of an azimuth frequency, and data regarding an interval of a range frequency.

7. The signal processing apparatus according to claim 1, wherein
interpolating the first signal data includes executing a bulk compression process, mapping processing means for executing a mapping process, and resampling processing means for executing a resampling process.

8. A signal processing method comprising:
by one or more computers,
performing Fourier transform on a reflection signal into first signal data in a frequency domain, the reflection signal representing reflection from a scatterer with respect to radar emitted from a flying object;
generating a plurality of reference points arranged in a direction obliquely inclined with respect to a direction perpendicular to a traveling direction of the flying object in a plane defined by the traveling direction and an emission direction in which the flying object emits the radar;
calculating each phase of second signal data in the frequency domain after Fourier transform on the reflection signal when the radar is virtually emitted to the plurality of reference points;
generating an interpolation formula by using each phase of the second signal data; and
interpolating the first signal data by using the interpolation formula, and performing inverse Fourier transform.

9. The signal processing method according to claim 8, wherein
the obliquely inclined direction is the emission direction.

10. The signal processing method according to claim 9, further comprising:
acquiring third signal data based on a first coordinate system among pieces of data obtained by performing inverse Fourier transform on the first signal data, and transforming the third signal data into fourth signal data based on a second coordinate system different from the first coordinate system, wherein
the first coordinate system has one axis representing a distance from the flying object to the scatterer in the emission direction, and the other axis representing a time when a center of the radar emitted by the flying object passes through the scatterer, and
the second coordinate system has one axis representing a distance from the flying object to the scatterer in the direction perpendicular to the traveling direction, and the other axis representing a time when the distance between the flying object and the scatterer is closest.

11. The signal processing method according to claim 9, further comprising:
transforming position information of pixel data associated with data obtained by performing inverse Fourier transform on the first signal data into position information on the earth.

12. The signal processing method according to claim 9, further comprising:
generating the plurality of reference points by using position data related to a position of the flying object, emission data related to the emission direction, and topographical data.

13. The signal processing method according to claim 8, further comprising:
calculating each phase of the second signal data related to the reference point by further using trajectory data of the flying object, data regarding an interval of an azimuth frequency, and data regarding an interval of a range frequency.

14. A non-transitory computer-readable medium recording a program for causing a computer to execute:
a procedure of performing Fourier transform on a reflection signal into first signal data in a frequency domain, the reflection signal representing reflection from a scatterer with respect to radar emitted from a flying object;
a procedure of generating a plurality of reference points arranged in a direction obliquely inclined with respect to a direction perpendicular to a traveling direction of the flying object in a plane defined by the traveling direction and an emission direction in which the flying object emits the radar;
a procedure of calculating each phase of second signal data in the frequency domain after Fourier transform on the reflection signal when the radar is virtually emitted to the plurality of reference points;
a procedure of generating an interpolation formula by using each phase of the second signal data; and
a procedure of interpolating the first signal data by using the interpolation formula, and performing inverse Fourier transform.

15. The recording medium according to claim 14, wherein
the obliquely inclined direction is the emission direction.

16. The recording medium according to claim 15, wherein
third signal data is acquired based on a first coordinate system among pieces of data obtained by performing inverse Fourier transform on the first signal data, and the third signal data is transformed into fourth signal data based on a second coordinate system different from the first coordinate system,
the first coordinate system has one axis representing a distance from the flying object to the scatterer in the emission direction, and the other axis representing a time when a center of the radar emitted by the flying object passes through the scatterer, and
the second coordinate system has one axis representing a distance from the flying object to the scatterer in the direction perpendicular to the traveling direction, and the other axis representing a time when the distance between the flying object and the scatterer is closest.

17. The recording medium according to claim 15, wherein
position information of pixel data associated with data obtained by performing inverse Fourier transform on the first signal data is transformed into position information on the earth.

18. The recording medium according to claim 15, wherein
the plurality of reference points are generated by using position data related to a position of the flying object, emission data related to the emission direction, and topographical data.

19. The recording medium according to claim 14, wherein
each phase of the second signal data related to the reference point is calculated by further using trajectory data of the flying object, data regarding an interval of an azimuth frequency, and data regarding an interval of a range frequency.
